(19) United States
(12) Patent Application Publication
(10) Pub. No.: US 2010/0289626 A1
(43) Pub. Date: Nov. 18, 2010

(54) RADIO FREQUENCY IDENTIFICATION (RFID) ENABLED INVENTORY TRAY

(75) Inventors: Robert R. Oberle, Macungie, PA (US); Thomas Craig Weakley, Simpsonville, SC (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY INC., QUAKERTOWN, PA (US)

(21) Appl. No.: 12/729,108

(22) Filed: Mar. 22, 2010

Related U.S. Application Data
(60) Provisional application No. 61/163,128, filed on Mar. 25, 2009.

(51) Int. Cl. H04Q 5/22

(52) U.S. Cl. 340/10.42

(57) ABSTRACT

A tool tray can comprise a body with tool shaped recesses. A Radio Frequency Identification (RFID) tag can be positioned in one of the recesses. The RFID tag can be such that when no tool is placed in the one of the recesses, the tag is not detectable at a reading distance; but, when a corresponding tool is placed into the one of the recesses, the RFID tag is detectable from a reading distance.

### CLAIM OF PRIORITY

This application claims priority to U.S. Provisional Application No. 61/163,128 entitled “RFID ENABLED INVENTORY TRAY” by Robert R. Oberle, et al., filed Mar. 25, 2009, which is hereby incorporated by reference.

### BACKGROUND

The present invention relates to Radio Frequency Identification (RFID) based inventory systems.

### BRIEF DESCRIPTION OF FIGURES

FIG. 1 illustrates a tool tray with pre-fabricated recesses for placement of tools.

FIG. 2 illustrates a tool tray of the present invention with tools placed in their corresponding recesses.

### DETAILED DESCRIPTION OF THE INVENTION

Radio Frequency Identification (RFID) tags may be used to monitor the inventory of objects by attaching RFID tags to subject objects and monitoring the presence of the tags in the vicinity of an appropriately configured RFID reader system. This modality works well if the tag is smaller than the object and the object can be manipulated such that the tag is exposed to the electromagnetic field of the reader. The utility of this modality is limited should the RFID tags be large compared to the object or should the attachment of the tag limits the utility of the object itself. An example of the former would be the attachment of an RFID label to a small object such as an individual gemstone, of the latter is the attachment of an RFID tag to the handle of a surgical instrument.

The problems with attachment of tags not withstanding, there are often cases in which it is necessary to inventory vital components. The time required to do so manually is detrimental to the smooth operation of the overall system. An example is the requirement to inventory all the tools used to perform mission critical repairs to vehicles or machinery used in aviation or military systems. In these cases an auditable accounting of each tool is required to insure that none have been left behind after the repair has been affected. The mechanic's tools typically employed are generally subjected to physical abuse (drops, impact, prying etc . . . ) in the course of general use. The attachment of an electronic component such as an RFID tag or chip may not be suitable, owing to the nature of the work environment or the tag may itself interfere with the utility of the tool.

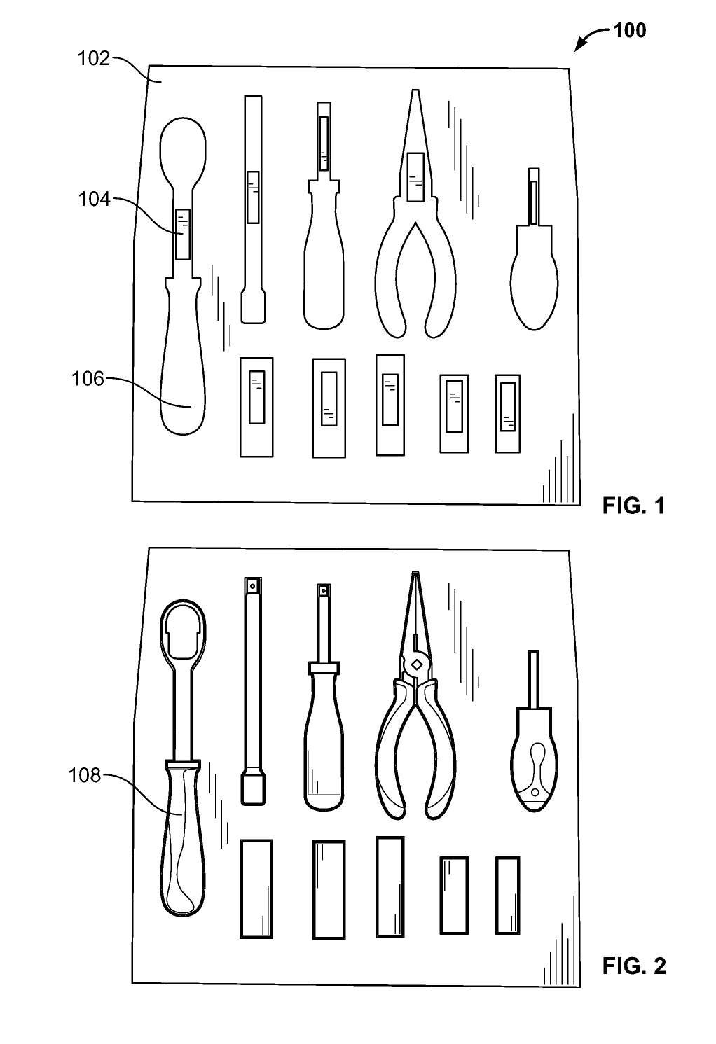

One embodiment of the present invention is shown in FIGS. 1 and 2. A tool tray 100 can comprise a body 102 with tool shaped recesses; and an RFID (Radio Frequency Identification) tag 104 positioned in one of the recesses 106. The recess 106 can be such when no tool is placed in the recesses 100, the tag is not detectable at a reading distance. When a corresponding tool 108 is placed into the recess 106, the RFID tag can be detectable from a reading distance.

RFID tags can be positioned in the multiple of the tool shaped recesses.

The RFID tag 104 can couple to the corresponding tool 108 when the corresponding tool 108 is put in position. The RFID tag 104 can be tuned to use a specific coupling to the corresponding tool 108.

In one embodiment, at least two RFID tags are tuned differently to compensate for different coupling effects of coupling to different tools when the tools are placed into the recesses.

One embodiment of the present invention is a system for taking inventory of a tray of tools based on the use of a RFID tags that couple to each tool when it is placed in its respective storage location. The tags can be integrated into the tool tray, which has recesses in the shape of the respective tools. The placement of the tool into the tray can activate the RFID tag by providing a coupling with the tag and allowing it to be read by a suitably configured RFID reader antenna, external to the tray. The tags can be constructed such that they are not responsive to the RFID reader unless the appropriate tool is placed in its corresponding recess. This can be accomplished through a combination of tag design and mechanical interlock of the tool and the tray i.e. the tag can require a specific coupling to the tool and the tools are not interchangeable among positions in the tray.

In one preferred embodiment a tool tray is configured such that there is a shaped recess corresponding to each tool, see FIG. 1; a tuned RFID tag can be incorporated into each recess. Each tag is tuned to respond only when in contact with the tool that corresponds with the position in the tray, i.e. coupled to the appropriate tool, see FIG. 2. The tray can be configured such that it may be moved into the read field of the RFID antenna.

Through use of the invention a traceable inventory of tools may be rapidly established.

In the configuration of FIG. 1, the RFID tags that are visible in the recesses are not active (read range is very short). In the configuration of FIG. 2, the RFID tags can be read at a distance (3-6 feet, for example).

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A tool tray comprising:
a body with tool shaped recesses; and
a Radio Frequency Identification (RFID) tag positioned in one of the recesses, wherein the RFID tag is such that when no tool is placed in the one of the recesses, the tag is not detectable at a reading distance, but when a corresponding tool is placed into the one of the recesses, the RFID tag is detectable from a reading distance.

2. The tool tray of claim 1, wherein the RFID tags are positioned to multiple tool shaped recesses.

3. The tool tray of claim 2, wherein the RFID tags are positioned in each of the tool shaped recesses.

4. The tool tray of claim 1, wherein the RFID tag couples to the corresponding tool when the corresponding tool is in position in the recesses.

5. The tool tray of claim 4, wherein the RFID tag is tuned to use a specific coupling with the corresponding tool.

6. The tool tray of claim 1, wherein at least two of the RFID tags positioned in the tool shaped recesses' are tuned differently.

7. The tool tray of claim 6, wherein at least two RFID tags are tuned differently due to different coupling efforts of coupling to different tools when the tools are placed into recesses.
